(19) United States
(12) Patent Application Publication
(10) Pub. No.: US 2025/0198555 A1
(43) Pub. Date: Jun. 19, 2025

(54) LATCH SYSTEMS AND METHODS FOR FLUID LINE COUPLING

(71) Applicant: GM GLOBAL TECHNOLOGY OPERATIONS LLC, Detroit, MI (US)

(72) Inventors: Seungha Oh, Bucheon-si (KR); Wonjoon Choi, Gyeonggi-do (KR); Kyoungseok Joo, Incheon (KR); Seonjeong Huh, Seoul (KR)

(73) Assignee: GM GLOBAL TECHNOLOGY OPERATIONS LLC, Detroit, MI (US)

(21) Appl. No.: 18/539,252

(22) Filed: Dec. 13, 2023

(51) Int. Cl. F16L 37/098

(52) U.S. Cl. CPC F16L 37/098

(57) ABSTRACT

A latch system and method for a fluid line coupling. The latch system includes a coupling that has a connector and a port that provide the coupling as a mating fluid connection. A primary latch secures the connector to the port. A secondary latch secures the connector to the port and ensures the primary latch is engaged. The secondary latch includes a latch arm that is movable into the connector, and that ensures the primary latch is in a latched position. The secondary latch includes a lock tab on the latch arm. The lock tab engages the connector to lock the secondary latch in the connector.

### INTRODUCTION

The present disclosure generally relates to latching fluid line connections and more particularly relates to systems and methods that include a secondary latch to ensure a secure connection is provided between two parts of a fluid line, such as at a releasable coupling.

In various types of machinery, equipment and other devices many types of fluid conveying lines may be employed as conduits for conveying fluid flow and/or pressure. Releasable connectors may be employed to provide a convenient way to assembly and disassemble one section of a fluid line to another. For example, quick connectors may be employed where a spigot (coupling plug) on one section of the fluid conduit is received in a socket (coupling body) on a separate section of the fluid conduit with a latch mechanism to hold the two parts together and to allow fluid to flow between the two sections. Quick connect fittings are often used as a way to quickly connect and disconnect pipes and hoses in a variety of applications and without special tools. The latch mechanism may be releasable so that the plug may be selectively removed from the socket. The latch mechanism may be a snap type of a spring, ring, or ball latching mechanism that automatically locks the two halves of the connector fitting when they are pushed together. A releasing sleeve or button may be employed to release the latch and to unlock the connection. Other quick connect fittings may not include a latch.

Because connectors may be intended to provide convenient and ergonomically friendly ways of making connections, a quick closure is preferred. Generally, the plug is simply inserted into, and seated in, the socket. With fluid line connectors there is a risk of the fitting not being fully inserted, of becoming loose, or of separating, which could result in leakage or a failure to properly convey fluid. As a result, a way of ensuring a secure connection is desirable.

Accordingly, it is desirable to provide fluid line connectors with a system to ensure that the closure mechanism of the connection may only be closed if the connector is fully secured. Furthermore, other desirable features and characteristics of the present invention will become apparent from the subsequent detailed description and the appended claims, taken in conjunction with the accompanying drawings and the foregoing introduction.

### SUMMARY

Latch systems and methods are provided for a fluid line coupling. In a number of embodiments, the latch system includes a coupling that has a connector and a port that together provide the coupling as a mating fluid connection. A primary latch secures the connector to the port. A secondary latch secures the connector to the port and ensures the primary latch is engaged. The secondary latch includes a latch arm that is movable into the connector, and that ensures the primary latch is in a latched position. The secondary latch includes a lock tab on the latch arm. The lock tab engages the connector to lock the secondary latch in the connector with the primary latch and the secondary latch fully secured.

In additional embodiments, the secondary latch has a body where the latch arm extends from the body and a handle extends from the body. The handle is for manipulation of the secondary latch to secure the secondary latch.

In additional embodiments, the secondary latch has a body and the latch arm extends from the body in a selected direction. The latch system includes a spacer extending from the body in another direction that is opposite the selected direction.

In additional embodiments, the port is formed with a shaft. The secondary latch has a pair of clip legs that clip onto the shaft.

In additional embodiments, the port has a shaft with a bead formed around the shaft. The primary latch includes a clip that clips the connector onto the port against the bead.

In additional embodiments, the latch arm of the secondary latch is extends out of the connector when the coupling is fully engaged and serves as a release for the secondary latch from the connector.

In additional embodiments, the secondary latch has a body that is semi-cylindrical in shape. The port includes a shaft and the body clips onto the shaft.

In additional embodiments, the latch arm has a terminal end. The port has a shaft that is hollow, with a bead on an outside of the shaft. The terminal end engages the bead to ensure the shaft is fully engaged within the connector.

In additional embodiments, the port has a shaft, with a bead on an outside of the shaft. The primary latch has a clip with a curved segment that engages the shaft adjacent the bead to secure the port and the connector together. The latch arm of the secondary latch has a terminal end that engages the bead to ensure the curved segment seats against the shaft at the bead.

In additional embodiments, the connector has a bell section and a tube section. The primary latch is contained in the bell section and the secondary latch is constructed to be inserted into the bell section. The secondary latch has a lock tab that engages the bell section to secure the coupling together.

In a number of additional embodiments, a method of coupling a fluid line with a latch system includes constructing a mating fluid connection from a coupling that has a connector and a port. A primary latch secures the connector to the port. A secondary latch secures the connector to the port. The secondary latch ensures engagement of the primary latch. A latch arm of the secondary latch moves into the connector. The secondary latch ensures that the primary latch is in a latched position. A lock tab on the latch arm of the secondary latch engages with the connector to lock the secondary latch in the connector.

In additional embodiments, a body is provided on the secondary latch. The latch arm extends from the body. A handle extends from the body. The handle is manipulated to secure the secondary latch.

In additional embodiments, a latch arm and a spacer extend from the body of the secondary latch in opposite directions.

In additional embodiments, the port is constructed to have a shaft. The secondary latch has a pair of clip legs. The secondary latch is clipped onto the shaft by the clip legs.

In additional embodiments, the port is constructed as a shaft with a bead formed around the shaft. The primary latch is constructed to have a clip. The clip is used to clip the connector onto the port with the primary latch positioned against the bead.

In additional embodiments, the latch arm of the secondary latch extends out of the connector when the coupling is fully engaged. The secondary latch is released from the connector by the latch arm.

In additional embodiments, the secondary latch is constructed to have a body that is semi-cylindrical in shape. A shaft is included as part of the port. The body of the secondary latch is clipped onto the shaft.

In additional embodiments, the latch arm is constructed to have a terminal end. The port is constructed to have a shaft that is hollow, and with a bead on an outside of the shaft. The terminal end is engaged with the bead to ensure the shaft is fully engaged within the connector.

In additional embodiments, the port is constructed to have a shaft, with a bead on an outside of the shaft. The primary latch is constructed to have a clip with a curved segment. The curved segment engages the shaft adjacent the bead to secure the port and the connector together. A terminal end of the latch arm engages the bead to ensure the curved segment seats against the shaft at the bead.

In a number of other embodiments, a latch system for a fluid line coupling of a vehicle includes a coupling with a connector and with a port on the vehicle. The connector and the port together make up the coupling as a mating fluid connection. A primary latch secures the connector to the port. A secondary latch also secures the connector to the port and acts to ensure the primary latch is engaged. The secondary latch includes a latch arm that moves into the connector. The latch arm includes a terminal end that engages the port to ensure the primary latch is in a latched position. The secondary latch includes a lock tab on the latch arm. The lock tab engages the connector to lock the secondary latch in the connector.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic diagram of a vehicle with a fluid line coupling latch system, in accordance with various embodiments;

FIG. 2 is an illustration of the coupling of the vehicle of FIG. 1 in a primary latched state, in accordance with various embodiments;

FIG. 3 is an illustration of the coupling of the vehicle of FIG. 1 in a secondary latched state, in accordance with various embodiments;

FIG. 4 is a plan view illustration showing aspects of the primary latch for the connector of the vehicle of FIG. 1, in accordance with various embodiments;

FIG. 5 is a perspective illustration showing aspects of the secondary latch for the connector of the vehicle of FIG. 1, in accordance with various embodiments;

FIG. 6 is a plan view illustration of the secondary latch for the connector of the vehicle of FIG. 1, in accordance with various embodiments; and

FIG. 7 is a sectional illustration of the fluid line coupling latch system of the vehicle of FIG. 1, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description.

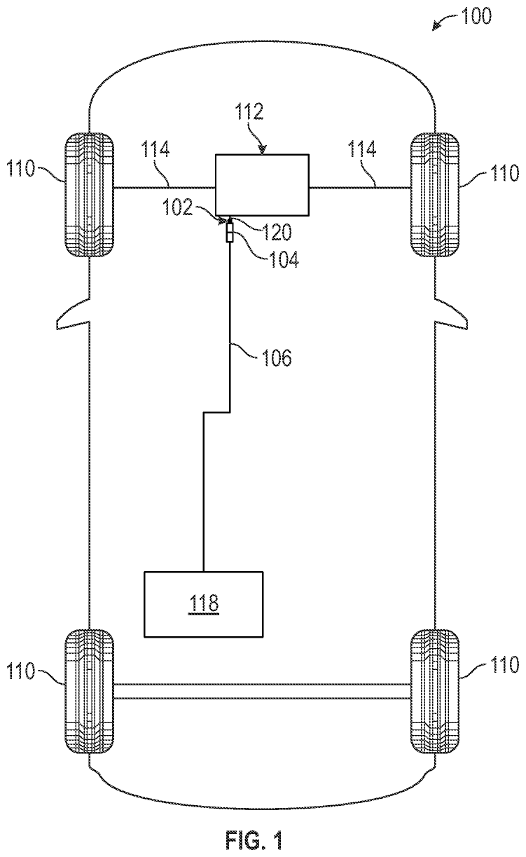

With reference to FIG. 1, illustrated is an example of a vehicle 100 with a latch system 102 of a coupling 104 in a fluid line 106. As depicted in FIG. 1, the vehicle 100 generally includes a structure including a body 108, supported on wheel assemblies 110, such as by a suspension assembly (not shown). The body 108 may be of various types that define a physical shape for desired purposes. The body 108 substantially encloses components of the vehicle 100 and defines exterior surfaces, and the wheel assemblies 110 are each rotationally coupled near a respective corner of the body 108. In various embodiments, the vehicle 100 may be a front wheel drive vehicle as shown, a rear wheel drive vehicle, or an all-wheel drive vehicle with any number of wheels, however other drive arrangements are contemplated.

Propulsion of the vehicle 10, such as on a roadway, is provided by a propulsion system 112. The propulsion system 112 may be any of various types such as electric, internal combustion, hybrid, or others. Torque generated by the propulsion system 112 is transferred to the wheel assemblies 110 through the driveline 114. The driveline 114 includes a number of torque transfer elements that may be coupled with any number of the wheel assemblies 110. In this embodiment, the propulsion system 112 is coupled with the front wheel assemblies 110 through a pair of half-shafts of the driveline 114.

In the current embodiment the propulsion system 112 uses a fluid, such as a fuel, and is coupled with a fluid tank 118 by the fluid line 106. The propulsion system 112 is connected with the fluid line 106 by the coupling 104. The coupling 104 is associated with a port 120 on the propulsion system 112. In this embodiment, the port 120 is an engine port through which fuel is delivered to the propulsion system 112 from the fluid tank 118. In a number of embodiments, the port 120 may be any element that is configured to couple with a mating element of the coupling 104 to provide a fluid communicating connection. For example, the port 120 may be a connector, a plug, a tube, a spigot, or other structure. The connection between the port 120 and the fluid line 106 through the coupling 104 is secured by the latch system 102, which is described in more detail below.

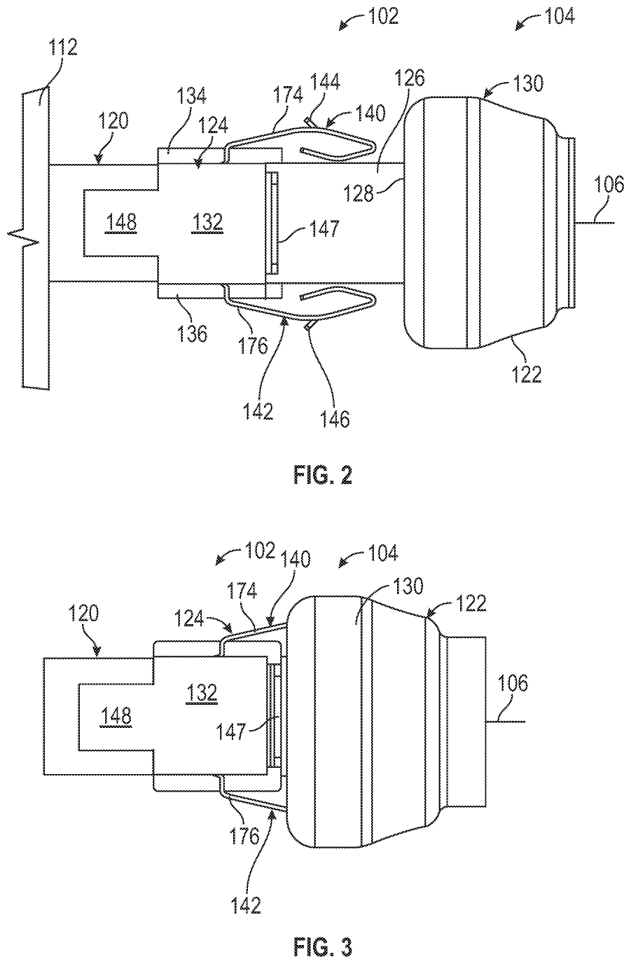

Referring additionally to FIG. 2 with continued reference to FIG. 1, the coupling 104 includes the port 120, a connector 122 and the latch system 102. The latch system 102 includes a primary latch (described below) that is concealed in the connector 122 in the view of FIG. 2 and includes a secondary latch 124. The port 120 includes a shaft 126 and a bead 128. The shaft 126 is tubular and hollow to channel fluid, and the bead 128 is shaped as an annular ring that encircles the outside of the shaft 126 and may be formed as an integral piece thereof.

The connector 122 includes a fitting housing 130, which includes various components as described below. In a number of embodiments, the secondary latch 124 is positioned on the port 120, and specifically on the shaft 126 thereof and is slidable along the shaft 126. As shown in FIG. 2, the shaft 126 of the port 120 is in the process of being inserted into the fitting housing 130 of the connector 122 and is currently inserted up to the bead 128.

The secondary latch 124 includes a body 132 that is semi-cylindrical in shape and includes a pair of clip legs 134, 136 so that it clips onto the shaft 126 of the port 120. The secondary latch 124 also includes a pair of latch arms 140, 142 that extend from the body 132 and that are configured to be inserted into the fitting housing 130. The latch arms 140, 142 have respective lock tabs 144, 146 that are configured to lock into the fitting housing 130. The secondary latch 124 also includes a handle 147 that extends from the body 132 in a direction away (radially) from the shaft 126. In relation to the coupling 104, a radial direction is a direction perpendicular and outward from the center of the fluid passage through the coupling 104 and a longitudinal direction is a direction along or parallel to the center of the fluid passage. The handle 147 is configured to be grasped by an operator and manipulated to slide the secondary latch 124 along the shaft 126. The secondary latch 124 also includes a spacer 148 that extends (longitudinally) from the body 132 on a side opposite the handle 147 and extends along the shaft 126 to space the handle 147 away from the propulsion system 112 so that it may be readily accessed and grasped. It will be understood that the handle 147 may be manipulated by a human operator or by a machine operator.

As shown in FIG. 3, the port 120 is further inserted into the fitting housing 130 of the connector 122. The latch arms 140, 142 extend into the fitting housing 130 and the handle 147 is positioned adjacent the fitting housing 130. The lock tabs 144, 146 are positioned inside the fitting housing 130 to hold the port 120 and the secondary latch 124 in position. This ensures the port 120 is fully inserted into the connector 122. The insertion using the handle 147 assists in visually confirming whether port 120 is fully inserted to ensure a secure connection.

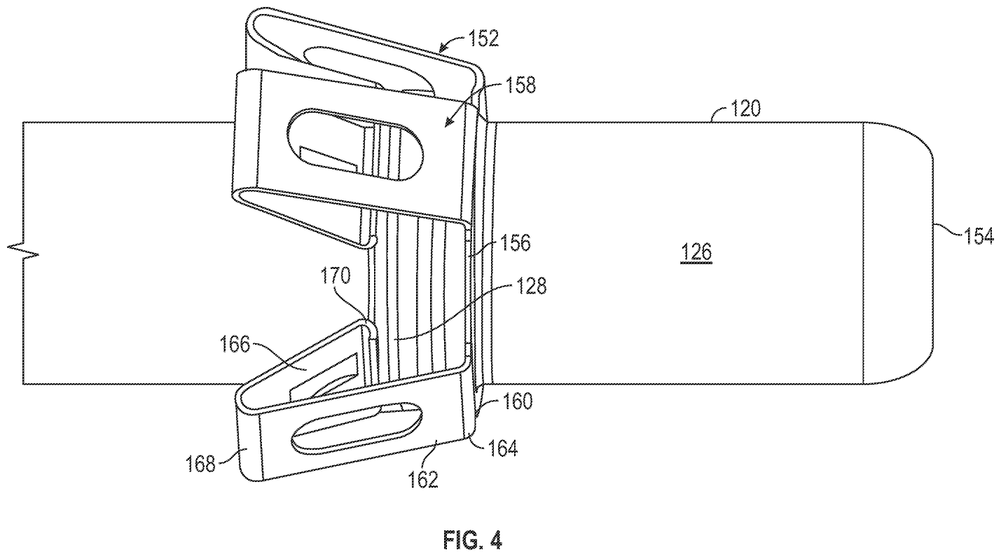

Referring to FIG. 4, the port 120 is shown without the secondary latch 124 and with the primary latch 152 on a secured position relative to the port 120. In this view, the primary latch 152 is removed from the fitting housing 130 of the connector 122 where it normally resides, to demonstrate the respective fully connected relative positions. The port 120 includes the shaft 126 and the bead 128. The shaft 126 includes a terminal end 154 that is spaced away from the bead 128 and is in the lead when the connector 122 is coupled onto the port 120.

The primary latch 152 includes a ring 156 through which the shaft 126 extends and that is positioned between the bead 128 and the terminal end 154. A number of clips 158 extend from the ring 156. In the current embodiment there are four clips 158, three of which are visible in FIG. 4. Each clip 158 includes a segment 160 extending radially outward from the ring 156, and a segment 162 extending from the segment 160 and bent at an angle 164 relative to the segment 160. The angle 164 results in the segment 162 extending away from the terminal end 154 and disposed obliquely relative to the shaft 126. Another segment 166 extends from the segment 162 and is bent at an angle 168. The angle 168 results in the segment 166 extending toward the terminal end 154 from the angle 164 and results in the segment 166 extending obliquely relative to the shaft 126. A curved segment 170 is disposed at the end of the segment 166 opposite the angle 168. The curved segment 170 turns radially outward relative to the shaft 126. The shape of the clips 158 results in the curved segments 170 being in a position to clip onto the bead 128 and also being disposed against the shaft 126 when the port 120 fully moves into the connector 122.

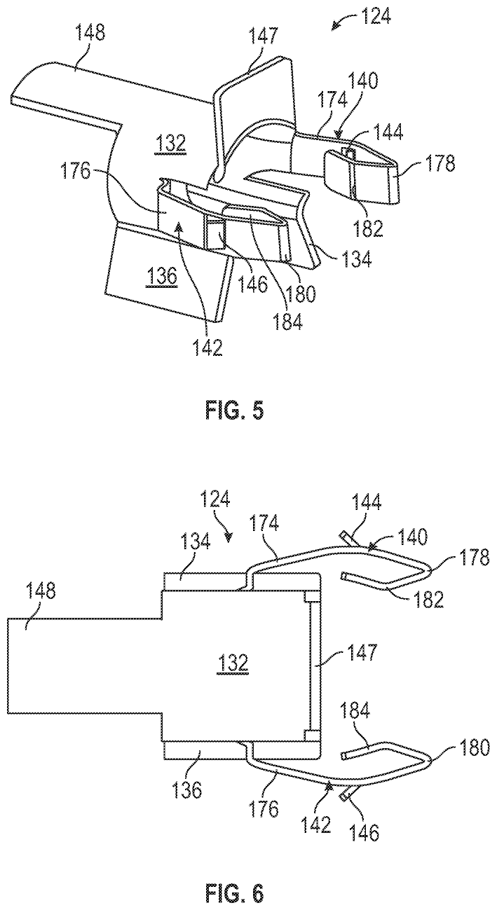

Referring to FIGS. 5 and 6, the secondary latch 124 is shown in isolation in perspective and plan views displaying its various details. These details include the body 132, the clip legs 134, 136, the latch arms 140, 142, the lock tabs 144, 146, the handle 147 and the spacer 148. As shown, it may be seen that the body 132 is semi-cylindrical in shape. Also visible is an opening 172 that is defined between the clip legs 134, 136, which allows the secondary latch 124 to be clipped onto the shaft 126 of the port 120 as shown in FIG. 2. The latch arms 140, 142 include the respective segments 174, 176 leading from the body 132 (longitudinally) to respective terminal ends 178, 180 that are formed by U-bends with reverse segments 182, 184 extending back (longitudinally) toward the body 132 from the terminal ends 178, 180. The lock tabs 144, 146 are formed on the segments 174, 176 and extend outward therefrom in the radial direction.

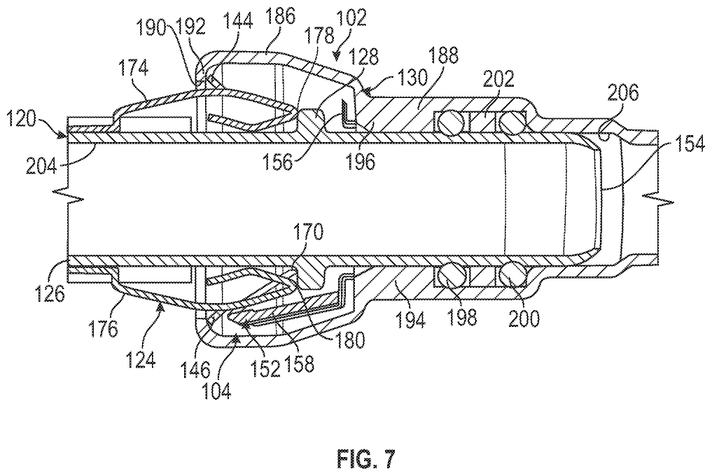

Referring to FIG. 7, the fully assembled and latched latch system 102 is shown sectioned for visibility including areas within the fitting housing 130. The port 120 is fully inserted into the connector 122 and both the primary latch 152 and the secondary latch 124 are latched. The primary latch 152 is shown in its normal housed position within the fitting housing 130. The secondary latch 124 is shown in its latched and locked condition with the lock tabs 144, 146 seated against the inside of the fitting housing 130.

The fitting housing 130 includes a bell section 186 and a tube section 188. The bell section 186 includes an opening 190 through which the port 120 extends after being inserted therethrough. The bell section 186 includes a wall 192 around the opening that extends radially and is annular in shape presenting a mating element for the lock tabs 144, 146 to engage. When the port 120 is inserted through the opening 190, the lock tabs 144, 146 and/or the latch arms 140, 142 flex radially inward to enter and when the port 120 is fully inserted, they flex radially outward for the lock tabs 144, 146 to engage the inside of the bell section 186 at the wall 192.

The fitting housing 130 houses the primary latch 152 in the bell section 186. With the port 120 fully inserted into the connector 122, the action results in the curved segments 170 of the clips 158 being disposed against the shaft 126 and against the bead 128, clipping onto the bead 128 when the port 120 moves fully into the connector 122. This engages the port 120 by the primary latch 152 to hold the connector 122 on the port 120. In embodiments, the connector 122 may be removeable from the port 120, such as for service purposes, and a release tool (not shown) may be used to spread the latch arms 140 to release the bead 128.

The tube section 188 of the fitting housing 130 includes a guide 194 with a ramp 196 facing the opening 190 to center and align the port 120 when coupling with the connector 122. Inboard from the guide 194 the tube section 188 houses a pair of seals 198, 200, separated by a spacer 202. The seals may be resilient O-ring seals and may engage the shaft 126 to provide a fluid-tight seal between the connector 122 to the port 120. The port 120 includes an opening 204 through the shaft 126 and the fitting housing 130 includes an opening 206 that extends through its entire length so that fluid may move through the coupling 104.

To complete an assured, secure connection of the coupling 104, the port 120 and the connector 122 are brought together with the terminal end 154 entering the opening 190. The terminal end 154 of the shaft 126 moves through the opening 190 of the bell section 186. The primary latch 152 is positioned in the bell section 186 and the terminal end 154 moves through it, inside the curved segments 170. The terminal end 154 is next guided by the ramp 196 of the guide 194 to a centered position within the connector 122. The terminal end 154 next moves through the seals 198, 200. At substantially the same time, the bead 128 moves through the primary latch 152 spreading the clips 158. When fully inserted as shown, the curved segments 170 clip onto the bead 128 and the primary latch 152 is secured. However, in a case where the full insertion is not completed, the clipping action may not occur.

To ensure that the clipping action of the primary latch 152 occurs, the secondary latch 124 is slid along the shaft 126 so that the latch arms 140, 142 enter the opening 190. As manipulated by the handle 147 (FIG. 5), the secondary latch 124 moves and the terminal ends 178, 180 will contact the bead 128, and, if not fully clipped, will move the bead 128 into position so that the curved segments 170 clip in place adjacent the bead 128 and move against the shaft 126. This ensures the primary latch 152 is fully secured. Substantially simultaneously, the lock tabs 144, 146 clear the opening 190 and flex outward locking the secondary latch 124 within the connector 122. As a result, the secondary latch 124 ensures the primary latch 152 is fully engaged and tactile feedback, such as a snapping action, on the handle 147 alerts the operator that the secondary latch 124 is fully engaged and locked. The connection provided by the coupling 104 is therefore, secure and leak-free. In some embodiments, the secondary latch 124 may be attached to the connector 122, rather than to the port 120, to be ready for use prior to engagement of the coupling 104.

To uncouple the coupling 104, such as when servicing of the fluid line 106 or the propulsion system 112 is desirable, the latch arms 140, 142, and specifically part of the segments 174, 176, extend out of the opening 190 and remain accessible. The latch arms 140, 142 may be pressed together to move the lock tabs 144, 146 radially inward to a position that will clear, and move through, the opening 190. The handle 147 may be used to slide the secondary latch 124 along the shaft 126 and out of the connector 122. Then, access is available to disengage the primary latch 152, such as through the use of a tool to compress the clips 158.

Accordingly, a latch system and method includes a secondary latch to ensure the primary latch is fully engaged and ensure a secure connection. The secondary latch may be employed without the need of a separate tether to connect is in the latch system. The secondary latch may be manufactured using a polymer, a metal, or other material. A handle feature may be included for manipulation of the secondary latch and for providing tactile feedback to the operator. A locking feature in the form of lock tabs may be included for locking purposes to hold the secondary latch after assembly to the inside of the connector. Latch arms may also function for disassembly of the coupling by pressing the latch arms which have flexibility. A spacer may ensure sufficient space to operate the secondary latch in the environment of the surrounding parts of the port, which may be an engine's fuel port. The secondary latch may be pre-assembled on the engine port or the connector, which avoids the need for a tether to hold the secondary latch. Moreover, an integral spacer increases clearance with other components when configuring the package and enhances assembly workability.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A latch system for a fluid line coupling, the latch system comprising:
a coupling comprising a connector and a port, wherein the connector and the port are configured to comprise the coupling as a mating fluid connection;
a primary latch configured to secure the connector to the port; and
a secondary latch configured to secure the connector to the port and to ensure the primary latch is engaged, the secondary latch comprising a latch arm configured to move into the connector, and to ensure the primary latch is in a latched position, and the secondary latch comprising a lock tab on the latch arm, the lock tab configured to engage the connector to lock the secondary latch in the connector.

2. The latch system of claim 1, wherein the secondary latch comprises a body wherein the latch arm extends from the body and comprising a handle extending from the body, wherein the handle is configured for manipulation of the secondary latch to secure the secondary latch.

3. The latch system of claim 1, wherein the secondary latch comprises a body, wherein the latch arm extends from the body in a first direction, and the latch system comprising a spacer extending from the body in a second direction, wherein the second direction is opposite the first direction.

4. The latch system of claim 1, wherein the port comprises a shaft, wherein the secondary latch comprises a pair of clip legs configured to clip onto the shaft.

5. The latch system of claim 1, wherein the port comprises a shaft with a bead formed around the shaft, wherein the primary latch comprises a clip configured to clip the connector onto the port against the bead.

6. The latch system of claim 1, wherein the latch arm of the secondary latch is configured to extend out of the connector when the coupling is fully engaged and to serve as a release for the secondary latch from the connector.

7. The latch system of claim 1, wherein the secondary latch comprises a body that is semi-cylindrical in shape, wherein the port includes a shaft and wherein the body is configured to clip onto the shaft.

8. The latch system of claim 1, wherein:
the latch arm comprises a terminal end,
the port comprises a shaft that is hollow, with a bead on an outside of the shaft, and
the terminal end is configured to engage the bead to ensure the shaft is fully engaged within the connector.

9. The latch system of claim 1, wherein:
the port comprises a shaft, with a bead on an outside of the shaft,
the primary latch comprises a clip with a curved segment configured to engage the shaft adjacent the bead to secure the port and the connector together, and
the latch arm of the secondary latch comprises a terminal end configured to engage the bead to ensure the curved segment seats against the shaft at the bead.

10. The latch system of claim 1, wherein the connector comprises a bell section and a tube section, wherein the primary latch is contained in the bell section and the secondary latch is configured to be inserted into the bell section, wherein the secondary latch comprises a lock tab configured to engage the bell section to secure the coupling together.

11. A method of coupling a fluid line with a latch system, the method comprising:
constructing a mating fluid connection from a coupling that has a connector and a port;
securing, by a primary latch, the connector to the port; and
securing, by a secondary latch, the connector to the port;
ensuring, by the secondary latch, engagement of the primary latch;
moving a latch arm of the secondary latch into the connector;
ensuring, by the secondary latch, that the primary latch is in a latched position; and
engaging a lock tab on the latch arm of the secondary latch with the connector to lock the secondary latch in the connector.

12. The method of claim 11, comprising:
providing a body on the secondary latch;
extending the latch arm from the body;
extending a handle from the body; and
manipulating the handle to secure the secondary latch.

13. The method of claim 11, comprising:
extending, from a body of the secondary latch and in a first direction, the latch arm; and
extending from the body of the secondary latch and in a second direction that is opposite the first direction, a spacer.

14. The method of claim 11, comprising:
constructing the port to have a shaft;
adding, to the secondary latch, a pair of clip legs; and
clipping, by the clip legs, the secondary latch onto the shaft.

15. The method of claim 11, comprising:
constructing the port as a shaft with a bead formed around the shaft; and
constructing the primary latch to have a clip; and
clipping, by the clip, the connector onto the port with the primary latch positioned against the bead.

16. The method of claim 11, comprising:
extending the latch arm of the secondary latch out of the connector when the coupling is fully engaged; and
releasing, by the latch arm, the secondary latch from the connector.

17. The method of claim 11, comprising:
constructing the secondary latch to have a body that is semi-cylindrical in shape;
including, as a part of the port, a shaft; and
clipping, the body of the secondary latch onto the shaft.

18. The method of claim 11, comprising:
constructing the latch arm to have a terminal end;
constructing the port to have a shaft that is hollow, and with a bead on an outside of the shaft; and
engaging the terminal end with the bead to ensure the shaft is fully engaged within the connector.

19. The method of claim 11, comprising:
constructing the port to have a shaft, with a bead on an outside of the shaft;
constructing the primary latch to have a clip with a curved segment;
engaging, by the curved segment, the shaft adjacent the bead to secure the port and the connector together; and
engaging, by a terminal end of the latch arm, the bead to ensure the curved segment seats against the shaft at the bead.

20. A latch system for a fluid line coupling of a vehicle, the latch system comprising:
a coupling comprising a connector and a port on the vehicle, wherein the connector and the port are configured to comprise the coupling as a mating fluid connection;
a primary latch configured to secure the connector to the port; and
a secondary latch configured to secure the connector to the port and to ensure the primary latch is engaged, the secondary latch comprising a latch arm configured to move into the connector, and the latch arm including a terminal end configured to engage the port to ensure the primary latch is in a latched position, and the secondary latch comprising a lock tab on the latch arm, the lock tab configured to engage the connector to lock the secondary latch in the connector.
